(19) United States
(12) Patent Application Publication
(10) Pub. No.: US 2025/0265399 A1
(43) Pub. Date: Aug. 21, 2025

(54) ANALYSIS METHOD AND ANALYSIS DEVICE

(71) Applicants: Global Unichip Corporation, Hsinchu (TW); Taiwan Semiconductor Manufacturing Company, Ltd., Hsinchu (TW)

(72) Inventors: Hsin-Hsiung Liao, Hsinchu (TW); Min-Hsiu Tsai, Hsinchu (TW)

(73) Assignees: Global Unichip Corporation, Hsinchu (TW); Taiwan Semiconductor Manufacturing Company, Ltd., Hsinchu (TW)

(21) Appl. No.: 18/623,050

(22) Filed: Apr. 1, 2024

(30) Foreign Application Priority Data
Feb. 19, 2024 (TW) 113105698

(51) Int. Cl. G06F 30/3315

(52) U.S. Cl. CPC G06F 30/3315

(57) ABSTRACT

An analysis method and an analysis device are provided. The analysis method includes the following. A static timing analysis is performed on a circuit model under test to select multiple selected signal paths violating timing constraints in the circuit model under test. Multiple timing information of each of the selected signal paths respectively under multiple operating conditions are obtained. Multiple selected timing information are selected from the timing information according to a first threshold, and a timing reference value corresponding to each of the operating conditions is calculated according to the selected timing information.

### CROSS-REFERENCE TO RELATED APPLICATION

This application claims the priority benefit of Taiwan application serial no. 113105698, filed on Feb. 19, 2024. The entirety of the above-mentioned patent application is hereby incorporated by reference herein and made a part of this specification.

### BACKGROUND

### Technical Field

The disclosure relates to a method and a device, and more particularly, to an analysis method and an analysis device.

### Description of Related Art

With the development of 2.5D chips and 3D chips, increasingly complex circuit structures have placed a considerable burden on circuit analysis, both in terms of computing performance and computing time. Generally speaking, when performing a circuit simulation or a circuit analysis, it is often necessary to adjust variation parameters of a process, a voltage, and a temperature to set a designed circuit under different operating conditions for analysis or simulation. However, the complex circuit structure leads to a significant increase in the number of operating conditions that is required to be considered during an analysis process, thus increasing the burden on a design or an analysis process of the existing circuit structure.

### SUMMARY

The disclosure provides an analysis method and an analysis device, which may reduce the analysis time of a circuit model under test.

An analysis method in the disclosure includes the following. A static timing analysis (STA) is performed on a circuit model under test to select multiple selected signal paths violating timing constraints from the circuit model under test. Multiple timing information of each of the selected signal paths under multiple operating conditions are obtained. Multiple selected timing information are selected from the timing information according to a first threshold, and a timing reference value corresponding to each of the operating conditions is calculated according to the selected timing information.

An analysis device in the disclosure includes a memory and a processor. The memory is configured to store a circuit model under test. The processor is configured to perform a static timing analysis (STA) on the circuit model under test to select multiple selected signal paths violating timing constraints from the circuit model under test, obtain multiple timing information of each of the selected signal paths under multiple operating conditions, and select multiple selected timing information from the timing information according to a first threshold, and calculate a timing reference value corresponding to each of the operating conditions according to the selected timing information.

Based on the above, the analysis device and the analysis method in the disclosure may effectively simplify the analysis time of the overall circuit model by calculating the timing reference value.

### BRIEF DESCRIPTION OF THE DRAWINGS

FIG. 1 is a block diagram of an analysis device according to an embodiment of the disclosure.

FIG. 2 is a flow chart of an analysis method according to an embodiment of the disclosure.

FIGS. 3A to 3F are flow charts of an operation of an analysis method according to an embodiment of the disclosure.

### DETAILED DESCRIPTION OF DISCLOSED EMBODIMENTS

In a design process of a general digital circuit, a designer may first design a circuit through a circuit description language (e.g., VHDL, Verilog), and describe an implementation with register-transfer level (RTL) codes. Then, the designer performs logic synthesis on the designed RTL codes and converts the designed RTL codes into a logic gate circuit. Finally, the designer puts the logic gate circuit through automatic place and route (APR) to generate a circuit layout corresponding to a physical circuit. After the above steps are completed, according to a relationship of traces depicted on a circuit layout diagram, process parameters related to a physical structure may be further added to the logic gate circuit to perform a static timing analysis (STA) to determine whether timing performance of the physical circuit after APR may meet design requirements. When it is determined that the circuit after APR does not fully meet the design requirements in a result of STA, the designer may modify the original circuit by, for example, adjusting thrust of a portion of a driving circuit without changing functions of the circuit through an engineering change order (ECO). Furthermore, in order to ensure that the final circuit layout may meet the design requirements, including APR, STA and possible ECO that may be required, a loop formed by the steps may be repeatedly used to analyze and correct the input circuit until the final circuit layout diagram may meet the design requirements.

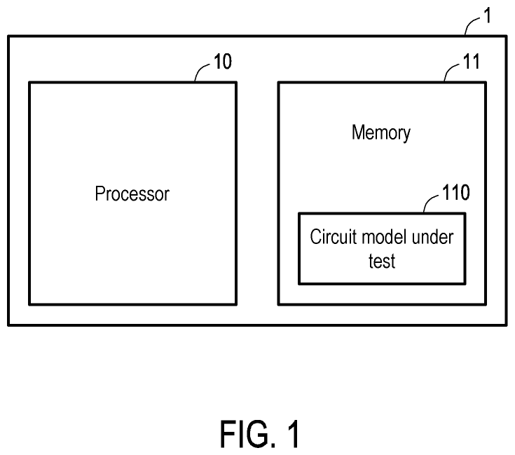

FIG. 1 is a block diagram of an analysis device 1 according to an embodiment of the disclosure. The analysis device 1 in FIG. 1 includes a processor 10 and a memory 11. The analysis device 1 may store a designed circuit model 110 under test in the memory 11. The processor 10 is coupled to the memory 11. The processor 10 may access the memory 11 to perform circuit design processes such as STA and ECO on the circuit model 110 under test. In this embodiment, the circuit model 110 under test stored in the memory 11 may be, for example, a circuit layout diagram generated after APR, and the processor 10 may set multiple operating conditions on the circuit model 110 under test and perform STA, thereby determining selected signal paths violating timing constraints from the circuit model 110 under test, and calculating worst-case proportion values of the selected signal paths in each of the operating conditions. Finally, the processor 10 may select at least one selected operating condition according to the calculated worst-case proportion value corresponding to each of the operating conditions. In this way, when the circuit model 110 under test is corrected through ECO in the subsequent steps before performing STA, the processor 10 may only set the corrected circuit model under test under the selected operating condition to perform STA, thereby speeding up the time required for an overall chip design.

In some embodiments, the processor 10 may be, for example, a central processing unit (CPU), other programmable general-purpose or special-purpose micro control units (MCU), a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), any other type of integrated circuit, state machine, advanced RISC machine (ARM) processor, or other similar elements or a combination of the above elements. In addition, the processor 10 may be a hardware circuit designed and implemented through a hardware description language (HDL) or any other design method of the digital circuit well known to those with ordinary knowledge in the art. In some embodiments, the memory 11 may be, for example, any type of fixed or removable random access memory (RAM), read-only memory (ROM), flash memory, hard disk drive (HDD), solid state drive (SSD), or similar elements or a combination of the above elements to store the circuit model 110 under test or necessary program codes for execution of the processor 10.

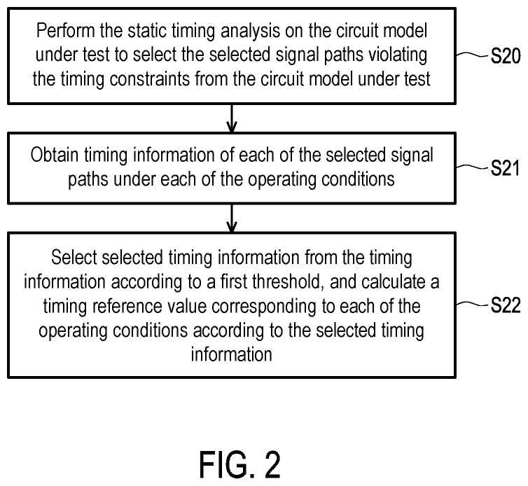

FIG. 2 is a flow chart of an analysis method according to an embodiment of the disclosure. The analysis method shown in FIG. 2 may be executed by the analysis device 1 in FIG. 1. The analysis method in FIG. 2 includes steps S20 to S22.

In step S20, the processor 10 may perform the static timing analysis on the circuit model 110 under test to select the selected signal paths violating the timing constraints from the signal paths included in the circuit model 110 under test. Specifically, when performing the static timing analysis, the processor 10 may set the circuit model 110 under test under different operating conditions, and obtain delays of all the signal paths in the circuit by performing the static timing analysis. In order to perform an extensive testing and analysis on the circuit model 110 under test, the processor 10 may set the circuit model 110 under test under various operating conditions to perform the static timing analysis by adjusting parameters such as process, voltage, and temperature (PVT). Therefore, the processor 10 may obtain delay information of all the signal paths in the circuit model 110 under test. For each of the operating conditions, the processor 10 may compare the delays of all the signal paths under the operating conditions with preset timing constraints to find the signal path to be recorded violating the timing constraints under the operating condition. Finally, after the processor 10 completes an analysis of all the operating conditions, the processor 10 may combine the signal paths to be recorded under all the operating conditions into the selected signal path.

In step S21, the processor 10 obtains timing information of each of the selected signal paths under each of the operating conditions. Specifically, for each of the selected signal paths, the processor 10 may calculate the delay of the selected signal path under all the operating conditions, and calculate a timing slack value of the selected signal path under each of the operating conditions compared to the timing constraints according to the delays and store the timing slack value as the timing information. Generally speaking, the timing slack value may be interpreted as a slack degree of the signal path compared to the timing constraints. The processor 10 may obtain the timing slack value by subtracting the timing constraints from the delay of the signal path. A negative timing slack value means that the signal path does not meet the timing constraints, and the smaller the timing slack value, the more the signal path lags behind the timing constraints.

In step S22, the processor 10 may select selected timing information from the timing information according to a first threshold, and calculate a timing reference value corresponding to each of the operating conditions according to the selected timing information. Specifically, for each of the selected signal paths, the processor 10 may select one or more timing information as the selected timing information according to the first threshold from the timing information corresponding to all the operating conditions of the selected signal path. Finally, for each of the operating conditions, the processor 10 may calculate statistics of the selected timing information under the operating condition, and calculate a proportion value of the statistics in all the timing information to be used as the timing reference value of the operating condition.

In some embodiments, the first threshold may be, for example, a preset range or a preset number. That is to say, for each of the selected signal paths, the processor 10 may select a preset number of the selected timing information, or the selected timing information that conforms to the preset range. For example, when the timing slack value is used as the timing information, for each of the selected signal paths, the processor 10 may select the minimum slack value and the corresponding operating condition thereof from the timing slack values of the selected signal path under all the operating conditions, and use the minimum slack value as the selected timing information. After determining the selected timing information of all the selected signal paths, for each of the operating conditions, the processor 10 may calculate a statistical value of the minimum slack value corresponding to each of the operating conditions as a proportion value of all the minimum slack values to serve as the timing reference value corresponding to each of the operating conditions.

In some embodiments, the processor 10 calculates the timing reference value corresponding to each of the operating conditions by dividing the number of minimum slack values corresponding to the operating condition by a total number of all the minimum slack values, and using a ratio of the two as the timing reference value corresponding to each of the operating conditions.

In some embodiments, the processor 10 calculates the timing reference value corresponding to each of the operating conditions by dividing a sum of the minimum slack values corresponding to each of the operating conditions by a ratio of the sum of all the minimum slack values, and using a ratio of the two as the timing reference value corresponding to each of the operating conditions.

In a certain aspect, the processor 10 may determine a timing performance of each of the selected signal paths under which operating conditions is relatively poor by determining the selected timing information and the corresponding operating condition thereof. Furthermore, the processor 10 may calculate a proportion value of the selected timing information corresponding to each of the operating conditions in all the selected timing information, and use the proportion value as the timing reference value to determine the probability or proportion of the relatively poor timing performance under the operating condition, so as to select the operating condition with the relatively poor timing performance as the selected operating condition according to the first threshold. In this way, after completing ECO and APR, the processor 10 is only required to set the corrected circuit model 110 under test to the selected operating condition with the relatively poor timing performance to perform the static timing analysis. The processor 10 is only required to observe whether the timing information of the selected signal path in the corrected circuit model 110 under test meets the timing constraints under the selected operating condition. When the processor 10 determines that the timing information of the selected signal path of the corrected circuit model 110 under test under the selected operating condition meets the timing constraints, the processor 10 may then perform the complete static timing analysis on the corrected circuit model 110 under test, that is, a static timing analysis including all the operating conditions.

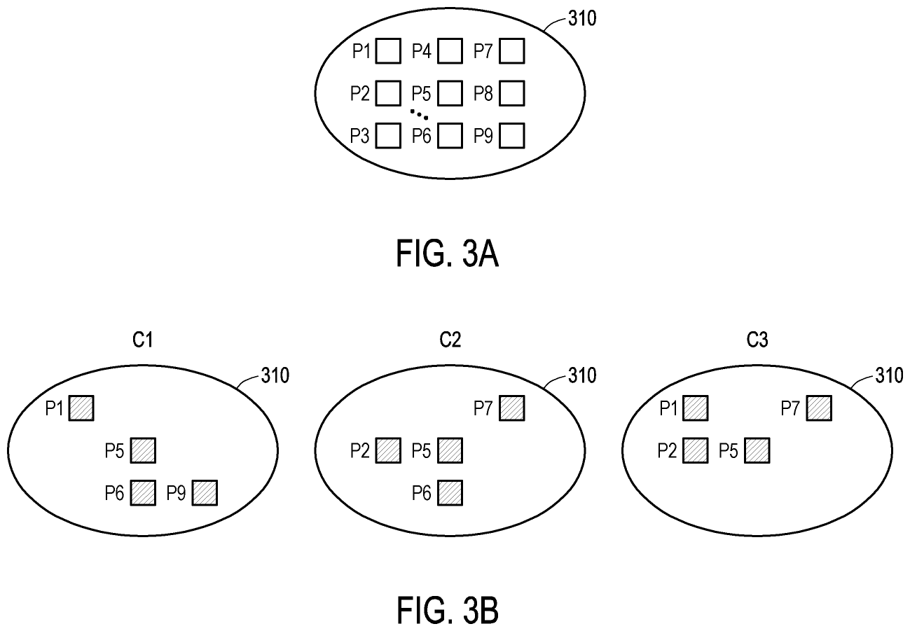

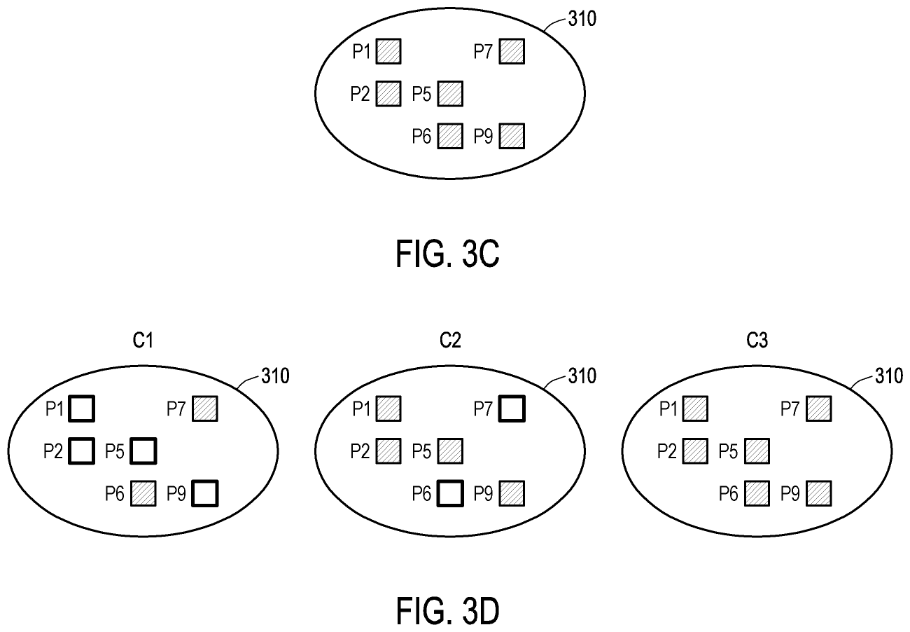

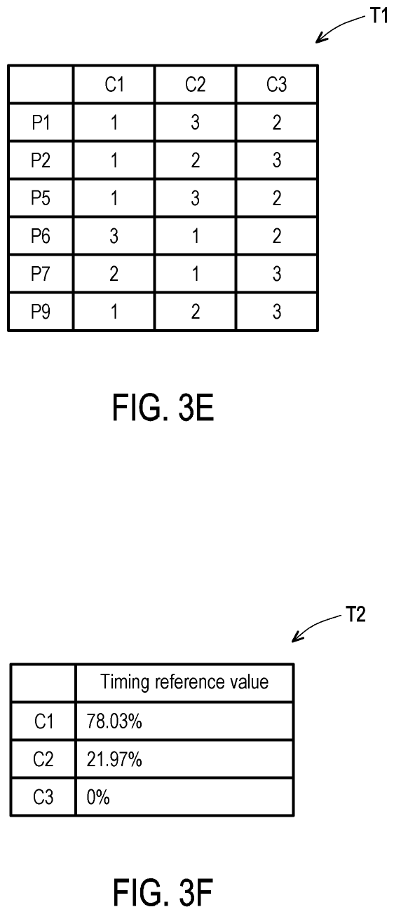

FIGS. 3A to 3F are flow charts of an operation of an analysis method according to an embodiment of the disclosure. The analysis method in FIGS. 3A to 3E may be performed, for example, by the analysis device in FIG. 1. In FIG. 3A, the processor 10 may perform the static timing analysis on a circuit model 310 under test to obtain timing information of multiple signal paths in the circuit model 310 under test under multiple operating conditions.

In FIG. 3B, the processor 10 may, for example, set the circuit model 310 under test under operating conditions C1 to C3 to perform the static timing analysis, and select the signal paths to be recorded violating the timing constraints in the circuit model 310 under test. In detail, the processor 10 may determine that under the operating condition C1, signal paths P1, P5, P6, and P9 in the circuit model 310 under test violate the timing constraints, under the operating condition C2, signal paths P2, P5, P6, and P7 in the circuit model 310 under test violate the timing constraints, and under the operating condition C3, signal paths P1, P2, P5, and P7 in the circuit model 310 under test violate the timing constraints.

In FIG. 3C, the processor 10 may combine all the signal paths to be recorded violating the timing constraints under each of the operating conditions into the selected signal paths. In this example, the processor 10 may combine all the signal paths to be recorded and select the selected signal paths P1, P2, P5, P6, P7, and P9.

In FIG. 3D, the processor 10 may determine the selected timing information and the operating condition corresponding to the selected timing information from the timing information. Specifically, for each of selected paths, the processor 10 may select the selected timing information from the timing information of the selected path under each of the operating conditions. For example, in an embodiment where the timing information is the timing slack value, for each of the selected paths, the processor 10 may compare the timing slack values of the selected signal paths in operating conditions C1 to C3, and select the minimum timing slack value as selected timing information. Then, the processor 10 may then calculate the minimum timing slack values corresponding to each of the operating conditions, thereby calculating the timing reference value corresponding to the operating condition.

Therefore, in FIG. 3D, the processor 10 may determine that the selected timing information of the selected signal paths P1, P2, P5, and P9 corresponds to the operating condition C1, and the selected timing information of the selected signal paths P6 and P7 corresponds to the operating condition C2.

FIG. 3E shows a determination process of the selected timing information. Table T1 in FIG. 3E shows an order of the timing slack values of the selected signal paths P1, P2, P5, P6, P7, and P9 in the operating conditions C1 to C3. As shown in the first column of Table T1, the signal path P1 has the minimum timing slack value under the operating condition C1, and has the maximum timing slack value under the operating condition C2. Therefore, the timing slack value of the signal path P1 under the operating condition C1 is determined as the selected timing information. The timing information corresponding to the selected signal paths P2, P5, P6, P7, and P9 may be derived by analogy. Therefore, the same details will not be repeated in the following.

In some embodiments, for each of the operating conditions, the processor 10 calculates a ratio of the number of minimum slack values corresponding to each of the operating condition divided by the total number of all the minimum slack values, and uses the ratio as the timing reference value. For example, taking the operating condition C1 as an example, the selected timing information of a total of the four selected signal paths P1, P2, P5, and P9 will correspond to the operating condition C1. Therefore, the processor 10 may divide the number of selected timing information corresponding to the operating condition C1 by a total number of the selected timing information, that is, dividing four by six to calculate the proportion value of the number of selected timing information corresponding to operating condition C1 among all the selected timing information, and using the proportion value as the timing reference value of the operating condition C1. Similarly, for the operating condition C2, the processor 10 may divide the number of selected timing information of the selected paths P6 and P7 corresponding to the operating condition C2 by the total amount of the selected timing information, that is, dividing two by six to calculate the proportion value of the number of selected timing information corresponding to the operating condition C2 among all the selected timing information.

In some embodiments, for each of the operating condition, the processor 10 may calculate a ratio of the sum of the minimum slack values corresponding to each of the operating conditions divided by the sum of all the minimum slack values, and use the ratio as the timing reference value. For example, taking the operating condition C1 as an example, the processor 10 may add up the minimum slack values of the selected signal paths P1, P2, P5, and P9 with the minimum slack values under the operating condition C1, and then divide it by the sum of the minimum slack values of all the selected signal paths P1, P2, P5, P6, P7, and P9 to calculate the proportion value of the minimum slack value corresponding to the operating condition C1 among all the minimum slack values. Finally, the processor 10 may use the proportion value as the timing reference value of the operating condition C1. Similarly, for the operating condition C2, the processor 10 may add up the minimum slack values of the selected signal paths P6 and P7 with the minimum slack value under the operating condition C2 to be divided by the sum of the minimum slack values of all the selected signal paths P1, P2, P5, P6, P7, and P9, and use the divided proportion value as the timing reference value of the operating condition C2.

FIG. 3F shows a determination process of the selected operating condition. After the processor 10 determines and calculates the timing reference value, the processor 10 may determine the selected operating condition according to the timing reference value. Table T2 in FIG. 3F shows the timing reference values of the operating conditions C1 to C3. Specifically, the processor 10 may sort all the operating conditions from large to small according to the timing reference value, and select which operating conditions as the selected operating conditions according to a second threshold. In this embodiment, the timing reference value may be, for example, the proportion value of the minimum slack value corresponding to the operating condition. In this way, the processor 10 may select the selected operating condition according to the sorted timing reference values from large to small until the sum of the timing reference values of the selected operating conditions is greater than the second threshold. In the example of FIG. 3F, the second threshold may be, for example, 95%. In this way, the processor 10 may select the operating conditions C1 and C2 as the selected operating conditions accordingly, so that the sum of the timing reference values of the selected operating conditions may be greater than the second threshold. In addition, in the subsequent analysis method, after the processor 10 performs ECO and APR on the circuit model 310 under test, it only necessary to set the corrected circuit model 310 under test under the selected operating conditions to perform the static timing analysis, which significantly simplifies the overall timing analysis time.

Based on the above, the analysis device and the analysis method in the disclosure may effectively simplify the analysis time of the overall circuit model by calculating the timing reference value.

What is claimed is:

1. An analysis method, comprising:
performing a static timing analysis (STA) on a circuit model under test to select a plurality of selected signal paths violating timing constraints from the circuit model under test;
obtaining a plurality of timing information of each of the plurality of selected signal paths under a plurality of operating conditions; and
selecting a plurality of selected timing information from the plurality of timing information according to a first threshold, and calculating a timing reference value corresponding to each of the plurality of operating conditions according to the plurality of selected timing information.

2. The analysis method according to claim 1, comprising:
setting the circuit model under test under each of the plurality of operating conditions to perform the static timing analysis;
according to the first threshold, selecting signal paths to be recorded violating the timing constraints under each of the plurality of operating conditions from the circuit model under test; and
combining the signal paths to be recorded under each of the plurality of operating conditions into the plurality of selected signal paths.

3. The analysis method according to claim 1, comprising
for each of the plurality of selected signal paths, determining a plurality of timing slack values violating the timing constraints under the plurality of operating conditions as the plurality of timing information; and
for each of the plurality of selected signal paths, selecting a minimum slack value from the plurality of corresponding timing slack values as the selected timing information.

4. The analysis method according to claim 3, comprising:
for each of the plurality of operating conditions, calculating a proportion value of the plurality of minimum slack values corresponding to the plurality of operating conditions relative to all the minimum slack values as each of the plurality of timing reference values.

5. The analysis method according to claim 4, wherein calculating each of the plurality of timing reference values comprises:
for each of the plurality of operating conditions, calculating a ratio of a number of the plurality of minimum slack values corresponding to each of the plurality of operating conditions divided by a total number of all the plurality of minimum slack values, and using the ratio as each of the plurality of timing reference values.

6. The analysis method according to claim 4, wherein calculating each of the plurality of timing reference values comprises:
for each of the plurality of operating conditions, calculating a ratio of a sum of the plurality of minimum slack values corresponding to each of the plurality of operating conditions divided by a sum of all the plurality of minimum slack values, and using the ratio as each of the plurality of timing reference values.

7. The analysis method according to claim 1, comprising:
according to the plurality of timing reference values, selecting at least one selected operating condition from the plurality of operating conditions, wherein a sum of at least one timing reference value corresponding to the at least one selected operating condition is greater than or equal to a second threshold.

8. The analysis method according to claim 7, comprising:
correcting the plurality of selected signal paths in the circuit model under test, and setting the corrected circuit model under test under the at least one selected operating condition to perform the static timing analysis.

9. An analysis device, comprising:
a memory configured to store a circuit model under test; and
a processor configured to:
perform a static timing analysis (STA) on the circuit model under test to select a plurality of selected signal paths violating timing constraints from the circuit model under test;
obtain a plurality of timing information of each of the plurality of selected signal paths under a plurality of operating conditions; and
select a plurality of selected timing information from the plurality of timing information according to a first threshold, and calculate a timing reference value corresponding to each of the plurality of operating conditions according to the plurality of selected timing information.

10. The analysis device according to claim 9, wherein the processor is configured to:
set the circuit model under test under each of the plurality of operating conditions to perform the static timing analysis;
according to the first threshold, select signal paths to be recorded violating the timing constraints under each of the plurality of operating conditions from the circuit model under test; and
combine the signal paths to be recorded under each of the plurality of operating conditions into the plurality of selected signal paths.

11. The analysis device according to claim 9, wherein the processor is configured to:
for each of the plurality of selected signal paths, determine a plurality of timing slack values violating the timing constraints under the plurality of operating conditions as the plurality of timing information; and
for each of the plurality of selected signal paths, select a minimum slack value from the plurality of corresponding timing slack values as the selected timing information.

12. The analysis device according to claim 11, wherein the processor is configured to:
for each of the plurality of operating conditions, calculate a proportion value of the plurality of minimum slack values corresponding to the plurality of operating conditions relative to all the minimum slack values as each of the plurality of timing reference values.

13. The analysis device according to claim 12, wherein a step of the processor calculating each of the plurality of timing reference values comprises:
for each of the plurality of operating conditions, calculating a ratio of a number of the plurality of minimum slack values corresponding to each of the plurality of operating conditions divided by a total number of all the plurality of minimum slack values, and using the ratio as each of the plurality of timing reference values.

14. The analysis device according to claim 12, wherein a step of the processor calculating each of the plurality of timing reference values comprises:
for each of the plurality of operating conditions, calculating a ratio of a sum of the plurality of minimum slack values corresponding to each of the plurality of operating conditions divided by a sum of all the plurality of minimum slack values, and using the ratio as each of the plurality of timing reference values.

15. The analysis device according to claim 9, wherein the processor is configured to:
according to the plurality of timing reference values, select at least one selected operating condition from the plurality of operating conditions, wherein a sum of at least one timing reference value corresponding to the at least one selected operating condition is greater than or equal to a second threshold.

16. The analysis device according to claim 15, wherein the processor is configured to:
correct the plurality of selected signal paths in the circuit model under test, and set the corrected circuit model under test under the at least one selected operating condition to perform the static timing analysis.
